(19) United States
(12) Patent Application Publication
(10) Pub. No.: US 2026/0111846 A1
(43) Pub. Date: Apr. 23, 2026

(54) Multi-User Real-Time Collaborative Editing Method Based on Virtual Nodes and Distributed Control

(71) Applicant: Guangzhou Yunbiaoju Network Technology Co., Ltd., Guangzhou (CN)

(72) Inventor: Yadong Zhang, Guangzhou (CN)

(21) Appl. No.: 19/176,453

(22) Filed: Apr. 11, 2025

(30) Foreign Application Priority Data
Oct. 22, 2024 (CN) 202411474657.1

(51) Int. Cl. G06Q 10/101; G06F 16/176; G06F 16/178

(52) U.S. Cl. CPC G06Q 10/101; G06F 16/1767; G06F 16/178

(57) ABSTRACT

This invention discloses a multi-user real-time collaborative editing method based on virtual nodes and distributed control, leveraging the Cooper distributed control architecture. By introducing control nodes such as Brokers, Curators and Binders, it ensures precise control and efficient handling of collaborative instructions, maintaining data consistency and system responsiveness while significantly enhancing real-time performance, stability, and scalability. Through the integration of Multi-Version Concurrency Control (MVCC) and real-time file system monitoring, the method supports concurrent multi-user editing and conflict management of the same file, optimizing system performance. The design includes virtual Peer nodes that seamlessly connect front-end editors with back-end services, improving compatibility and adaptability. The linkage mechanism between Brokers and Emitters achieves fine-grained processing and efficient distribution of instructions, optimizing system performance in high-frequency interaction scenarios. This technical approach overcomes the limitations of existing collaborative editing systems and provides an innovative, efficient, and stable solution for multi-user real-time collaboration.

### TECHNICAL FIELD

The invention pertains to the field of multi-user real-time collaborative editing and distributed data processing, specifically focusing on methods incorporating virtual nodes and distributed control.

### BACKGROUND TECHNOLOGY

Existing multi-user real-time collaborative editing systems are widely applied in areas such as code editing, document processing, and remote collaboration. These systems typically rely on network synchronization to ensure multiple users' edits to a shared file are reflected in real time. Traditionally, these systems adopt a centralized control architecture, where a central server manages all user operations and data synchronization.

However, this centralized approach often faces challenges in handling high concurrency and simultaneous multi-user operations, including command processing delays, data synchronization inconsistencies, and suboptimal system responsiveness. These issues negatively affect collaboration efficiency and user experience.

To address these limitations, decentralized architectures have been introduced, leveraging distributed nodes for data processing and synchronization to reduce server load and latency. However, current decentralized systems often employ simplistic command-processing mechanisms, which lack fine-grained control over collaborative instructions. This can lead to data inconsistencies and inefficiencies in conflict resolution, particularly in high-frequency interactive scenarios. Additionally, decentralized architectures often struggle with incomplete synchronization mechanisms and system stability issues.

To further improve the stability and data consistency of multi-user real-time editing, some systems have introduced single-lock mechanisms or basic conflict detection methods. However, these solutions often compromise editing freedom and reduce collaboration efficiency. Locking mechanisms, in particular, significantly degrade system performance and increase operation delays in high-concurrency scenarios, leading to a poor user experience. Furthermore, existing real-time file monitoring technologies are inefficient when dealing with complex file operations, making them inadequate for high-frequency multi-user interactions.

For enhanced compatibility and extensibility, existing technologies often integrate front-end editors with back-end services via plugins or additional configurations. However, this approach is complex, increases integration difficulty, raises system maintenance costs, and reduces flexibility.

Therefore, improving command processing efficiency, data consistency, and system stability in multi-user real-time collaborative editing systems has become a key technical challenge that this invention aims to solve.

### SUMMARY OF THE INVENTION

This invention addresses the deficiencies in existing technologies by providing a multi-user real-time collaborative editing method based on virtual nodes and distributed control. The method resolves issues such as command processing delays, data synchronization inconsistencies, poor conflict management, and limited system compatibility and extensibility.

To address these challenges, the invention employs the following technical solutions:
Step 1: Provide a distributed collaborative control system. It includes multiple control nodes such as Broker, Curator, Binder, and Emitter nodes. These nodes work within a distributed architecture to receive, process, and distribute commands efficiently.
Step 2: Create virtual Peer nodes in the front-end editor. These virtual Peer nodes act as a proxy between the front-end and the backend Cooper service, enabling seamless data transmission and command conversion. They also facilitate real-time interaction with the Cooper service.
Step 3: Use a multi-version concurrency control mechanism (MVCC) and a real-time file system monitoring mechanism to manage concurrent file editing. Monitor changes to the file and handle conflicts automatically, ensuring smooth synchronization among multiple users editing the same file in real-time.
Step 4: Utilize the linkage mechanism between Broker and Emitter nodes to process collaborative editing commands. Emitter nodes distribute the commands to the appropriate Broker nodes for processing. The Emitter evaluates the command type and returns results to the corresponding collaborative nodes, ensuring efficiency and accuracy in command processing.
Step 5: Employ a distributed control architecture to synchronize multi-user editing content in real-time. Ensure data consistency and real-time system responsiveness. Detect and respond to abnormal operations through the control nodes, enhancing the system's stability.

In a further embodiment of the invention, the virtual Peer nodes act as communication bridges between the editor and the backend service via the Vimcall protocol, enabling the joining, exiting, and data exchange of collaborative services.

In a further embodiment of the invention, the Broker node is responsible for receiving collaborative commands, the Curator node monitors changes in the file system and manages file subscriptions, the Binder node processes subscription messages for individual files and handles message broadcasting among subscribers, and the Emitter node serves as the external interaction interface for the system.

In a further embodiment of the invention, the multi-version concurrency control (MVCC) mechanism allows multiple users to simultaneously edit the same file, automatically detecting and resolving concurrent conflicts to ensure the real-time nature and consistency of the file content.

In a further embodiment of the invention, the real-time file system monitoring mechanism employs file system APIs, such as Linux's “inotify” or Windows's “FileSystemWatcher”, to achieve real-time monitoring and updating of files.

In a further embodiment of the invention, the distributed control system adopts a three-tier address design, enabling direct command interaction between the frontend, Gateway, and Cooper services to enhance the stability and responsiveness of data exchanges.

In a further embodiment of the invention, the system further includes a Cooper Service Manager module and a Peer Manager module, which are used to manage multiple Cooper service instances and the connection states of Peer nodes, enhancing the system's scalability and connection management capabilities.

In a further embodiment of the invention, command processing involves the collaboration between the Broker and Emitter based on an event-driven model. This distributed architecture ensures precise control and efficient processing of commands, optimizing system performance in high-frequency multi-user interaction scenarios.

In a further embodiment of the invention, data transmission is encrypted using SSL/TLS encryption protocols to ensure data security and privacy protection during the collaborative editing process.

In a further embodiment of the invention, users can invite other members to collaborate through external links, account searches, or email invitations and set different permission levels for each member to ensure the security and controllability of project data.

Compared with the prior technology, the beneficial effects of this invention are as follows:
1. The invention adopts the Cooper distributed control architecture, distinct from traditional centralized systems. By introducing control nodes such as Broker, Curator, and Binder, it achieves precise control and efficient processing of collaborative commands. The design utilizes the collaborative operation of multiple modules (e.g., the Vimcall mechanism of Peer nodes), ensuring data consistency and efficiency while maintaining decentralization. Unlike existing decentralized collaborative editing systems that commonly face command processing delays and data synchronization issues, this invention employs refined and layered designs with specialized modules. This significantly enhances the accuracy of data processing and the responsiveness of the system, improving real-time performance, stability, and scalability. The modular improvements are particularly advantageous in high-frequency multi-user interaction scenarios, greatly enhancing the user experience.
2. By integrating multi-version concurrency control (MVCC) and real-time file system monitoring technologies (e.g., Linux's inotify and Windows' FileSystemWatcher), the invention resolves conflicts that arise when multiple users simultaneously edit the same file. Traditional collaborative systems often rely on single locking mechanisms or simple conflict detection methods, which are insufficient for handling complex concurrency conflicts. The combined mechanisms in this invention not only ensure file real-time consistency but also significantly reduce the risks of inconsistencies caused by concurrency conflicts. This optimization improves the system's performance in real-time multi-user editing, providing more efficient synchronization and conflict management for a stable and smooth collaborative experience.
3. The introduction of virtual Peer nodes in the front-end editor enables direct interaction between the editor and Cooper services as a proxy through the Vimcall protocol, facilitating seamless front-end and back-end integration. This design overcomes the limitations of traditional collaborative systems, which often require additional plugins or complex configurations for front-end and back-end collaboration. The virtual node design greatly enhances system compatibility and flexibility. Particularly in scenarios requiring quick integration with existing front-end editors, this innovation reduces the complexity and time costs of system integration, making the collaborative editing system more adaptable and scalable, representing a major breakthrough in collaborative editing methods.
4. The introduction of a Broker-Emitter interaction mechanism in the system architecture ensures efficient execution of collaborative commands through fine-grained command processing and precise distribution. As a core interaction interface, the Emitter distributes commands to the appropriate Broker nodes for processing based on command types. Compared with the simple command processing methods in existing collaborative systems, this invention optimizes the speed and reliability of command execution, particularly in high-frequency interactions and complex collaborative scenarios. This logic provides the system with greater flexibility and adaptability, representing a significant enhancement over traditional collaborative architectures.

Further aspects and benefits of this invention will be partially detailed in the following descriptions, become evident from the descriptions, or be understood through the practice of this invention.

### FIGURES FOR ILLUSTRATION

To better explain the technical solutions in the embodiments of this invention or the prior technology, the following provides a brief introduction to the drawings used in the descriptions of these embodiments or the prior technology. It is evident that the drawings described below represent only some embodiments of this invention. For those skilled in the field, other drawings may be derived from these without creative efforts.

FIG. 1: A system architecture diagram of a multi-user real-time collaborative editing system based on virtual nodes and distributed control.

FIG. 2: The collaborative functional workflow of the Cooper system.

FIG. 3: The interaction architecture between the front-end and back-end services of the Cooper system.

### DETAILED IMPLEMENTATION

The technical solutions in the embodiments of this invention will be described clearly and comprehensively below. It is evident that the described embodiments represent only a portion of this invention's applications and not all of them. Based on the embodiments in this invention, all other embodiments obtained by those skilled in the field without creative efforts fall within the scope of this invention.

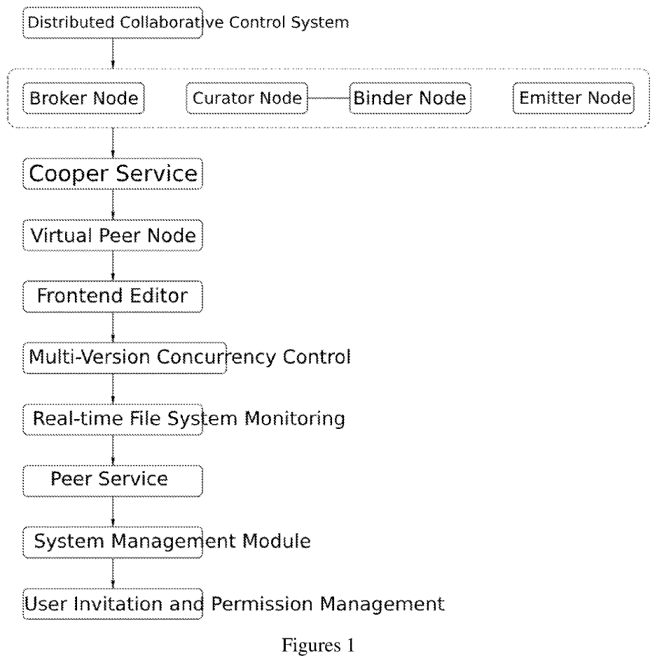

Refer to FIGS. 1-3 for the following description of a multi-user real-time collaborative editing method based on virtual nodes and distributed control, as implemented in this invention:
Step 1: Provide a distributed collaborative control system. It includes multiple control nodes such as Broker, Curator, Binder, and Emitter nodes. These nodes work within a distributed architecture to receive, process, and distribute commands efficiently.
Step 2: Create virtual Peer nodes in the front-end editor. These virtual Peer nodes act as a proxy between the front-end and the backend Cooper service, enabling seamless data transmission and command conversion. They also facilitate real-time interaction with the Cooper service.
Step 3: Use a multi-version concurrency control mechanism (MVCC) and a real-time file system monitoring mechanism to manage concurrent file editing. Monitor changes to the file and handle conflicts automatically, ensuring smooth synchronization among multiple users editing the same file in real-time.
Step 4: Utilize the linkage mechanism between Broker and Emitter nodes to process collaborative editing commands. Emitter nodes distribute the commands to the appropriate Broker nodes for processing. The Emitter evaluates the command type and returns results to the corresponding collaborative nodes, ensuring efficiency and accuracy in command processing.
Step 5: Employ a distributed control architecture to synchronize multi-user editing content in real-time. Ensure data consistency and real-time system responsiveness. Detect and respond to abnormal operations through the control nodes, enhancing the system's stability.

In a further embodiment of the invention, the virtual Peer node serves as a communication bridge between the editor and the backend service using the Vimcall protocol, facilitating the joining, exiting, and data interaction for collaborative services.

In a further embodiment of the invention, the Broker node is designed to receive collaborative commands, the Curator node monitors changes in the file system and manages file subscriptions, the Binder node handles subscription messages for individual files and broadcasts messages among subscribers, and the Emitter node functions as the system's external interaction interface.

In a further embodiment of the invention, the Multi-Version Concurrency Control (MVCC) mechanism is implemented to allow multiple users to simultaneously edit the same file, automatically detecting and resolving concurrent conflicts to ensure the real-time integrity and consistency of the file content.

In a further embodiment of the invention, the real-time file system monitoring mechanism employs file system APIs, such as “inotify” on Linux or “FileSystemWatcher” on Windows, to enable real-time file monitoring and updates.

In a further embodiment of the invention, the distributed control system adopts a three-segment address design, facilitating direct command interactions between the frontend, Gateway, and Cooper services, thereby improving the stability and responsiveness of data exchanges.

In a further embodiment of the invention, the system includes a Cooper Service Manager module and a Peer Manager module, which are responsible for managing multiple Cooper service instances and monitoring the connection status of Peer nodes, enhancing the system's scalability and connection management capabilities.

In a further embodiment of the invention, command processing is achieved through the collaboration of the Broker and Emitter nodes based on an event-driven model. This distributed architecture ensures precise command control and efficient handling, optimizing system performance in high-frequency, multi-user interaction scenarios.

In a further embodiment of the invention, SSL/TLS encryption protocols are utilized to encrypt data transmission, ensuring the security and privacy of data during collaborative editing processes.

In a further embodiment of the invention, users can invite other members to collaborate via external links, account searches, or email invitations. They can also assign different permission levels to participants, ensuring project data security and control.

### Example 1

### I. Cooper Control Data

### 1. System Architecture Design

Front End and Gateway: Responsible for displaying, saving, and controlling Cooper states. Participant information and collaboration states are stored in the database.

Cooper Service and Peer Nodes: Implement specific collaboration protocols. Peer nodes handle the reception, execution, and feedback of control commands via the Vimcall protocol, where execution is fully determined by the Peer nodes.

### 2. Handshake Data Structure:

Key information includes project ID, project path, username, write permission status, shadow path, etc.

### 3. Core Concepts Within Cooper Service:

Broker: Handles command processing logic, receives requests, and executes processing. Each functional module has its dedicated Broker.

Curator: Monitors directories and manages file subscriptions.

Binder: Processes subscription messages for individual files and broadcasts messages to multiple subscribers.

Emitter: Acts as the external interaction interface. Multiple Brokers can register Emitter callbacks, routing messages based on type to appropriate Brokers for processing and returning results.

### 4. System Enhancements and Improvements:

Newly added Broker and Emitter modules: Cooper business broker handles Cooper commands from the front end, processes them, and returns results. Vimcall emitter converts Vimcall data from the Gateway into OT (Operational Transformation) protocol data for the Cooper Business Broker and encapsulates results back into Vimcall responses.

Cooper service manager: Manages multiple Cooper Service instances, enhancing system scalability.

Connection Handle and Peer Manager: Connection Handle manages initial requests from Peer nodes (e.g., initializing and copying directories). Peer manager oversees Peer connections post-handshake, increasing flexibility in connection management.

Three-segment address design: Gateway and front end adapt to the new Cooper service three-tier address structure. Commands are directly routed to Cooper services, improving data interaction stability.

### 5. Exception Handling and Stability Enhancements:

Automatically detects and responds to anomalous commands from the front end, such as Vim connection interruptions.

Through the introduction of modules like Cooper Service Manager and Peer Manager, the system more effectively manages multiple Cooper Service instances and Peer connections, thereby enhancing overall stability and reliability.

### II. Cooper Function Design

### 1. System Architecture

The Cooper functionality is built on a distributed architecture and consists of five main components:
Initiator: Responsible for initiating collaboration requests.
Collaborator: Accepts collaboration requests and participates in collaborative editing.
Peer Service: Manages the synchronization of file editing content.
Cooper Service: Oversees the entire collaboration process and synchronizes file operations.
Gateway Service: Acts as middleware to forward messages between components.

### 2. Function Implementation

Collaboration Process: The initiator sends a collaboration request, which the collaborator accepts to create a collaboration project. Both sides exchange messages via WebSocket to enable real-time file editing and content synchronization. Any modifications made by either party are broadcast in real time to all collaborators, ensuring content consistency.

User invitations and permission management: Users can invite others to collaborate via external links, account searches, or email. Permission levels can be assigned to different collaborators to ensure data security and control.

File operation synchronization: In addition to real-time editing, operations like creating, renaming, or deleting files or folders initiated by the initiator are synchronized to all collaborators. These operations are sent as “fileSync” messages via WebSocket to the Peer Service, which processes the operations and broadcasts the results.

Ending collaboration: Either the initiator or collaborators can click the “Exit” button to send a termination request to the Gateway Service. The Gateway Service closes the collaboration session and notifies all collaborators via WebSocket to end the process.

### 3. Protocol Design

A comprehensive protocol system has been designed to cover various aspects of the collaboration process, including: Collaboration initiation protocol, file content editing protocol, cursor movement protocol, file operation synchronization protocol, collaboration termination protocol.

### Specific Implementation Details

### 1. Detailed Implementation of Control Data Structure

Project ID Management: Each collaborative project is assigned a unique identifier (Project ID).

Path and Permission Management: Every project is associated with a specific path (Project Path) and permission settings (Allow Writes), defining user access rights and operational permissions on project files.

Dynamic User Interface Rendering: The system dynamically renders the user interface based on user information (Username) and permissions, including access controls and visual elements.

### 2. Multi-Instance Directory Management Logic

Real-Time File System Monitoring: Uses file system APIs like Linux's “inotify” or Windows' “FileSystemWatcher” to monitor project directories in real-time.

Multi-Version Concurrency Control (MVCC): Implements MVCC to allow multiple users to edit the same file simultaneously while the system automatically handles concurrency conflicts.

### 3. Three-Segment Service Address Design

Service Discovery and Registration: Employs service discovery mechanisms such as Consul or Eureka for automatic registration and discovery of service instances.

Load Balancing: Utilizes load balancing technologies like Nginx or HAProxy to efficiently distribute requests across service instances, enhancing system availability and scalability.

### 4. Implementation of Internal Component Functions

Broker Component: Acts as the core of command processing, receiving and distributing collaboration operation commands. It adopts an event-driven model to improve processing efficiency.

Curator Component: Monitors file system changes and manages file subscriptions and version control.

Binder Component: Processes subscription messages for individual files and handles broadcasting messages to multiple subscribers.

Emitter Component: Serves as the unified interface for external system interactions, supporting various message types and interaction protocols.

### 5. Service Modification and Expansion

Plugin Architecture: Adopts a plugin-based architecture, allowing third-party developers to create and integrate new functional modules as needed.

API Extensions: Provides comprehensive API interfaces to support integration with other systems, such as project management tools and code repositories.

### 6. Exception Handling Mechanisms

Error Detection and Response: The system detects operational errors in real-time, such as network interruptions or insufficient permissions, and provides corresponding error handling and user prompts.

Log Recording and Auditing: All operations and exception events are recorded in system logs, facilitating issue tracking and security auditing.

### 7. Security and Privacy Protection

Data Transmission Encryption: All data transmissions are encrypted using SSL/TLS protocols to ensure the security of transmitted data.

Access Control: Implements strict access control policies to ensure that only authorized users can access sensitive data.

### Example 2

In current multi-user collaborative editing scenarios, such as software development teams working on coding, debugging, and version management, it is common for multiple developers to edit and modify the same project simultaneously. Traditional centralized collaborative editing systems, which rely on a single server to process all user requests, often face issues such as command processing delays, decreased system responsiveness under high concurrency, and data synchronization inconsistencies. These challenges lead to reduced collaboration efficiency and increase the risk of code conflicts and data loss.

To address these issues, the invention proposes a multi-user real-time collaborative editing method based on virtual nodes and distributed control. This method optimizes existing problems in typical code collaboration scenarios through the following approaches:

The invention introduces a Cooper distributed control architecture, distributing collaborative control tasks across multiple nodes, including Broker, Curator, Binder, and Emitter nodes. These nodes work together to share the load traditionally handled by centralized servers. In practical applications, when multiple developers edit code simultaneously, each user's editing commands are captured by the virtual Peer node of the front-end editor. Acting as a proxy for the Vimcall protocol, the Peer node converts and transmits front-end editing commands to the Cooper service. Cooper leverages its distributed architecture to efficiently process commands, ensuring that all collaborative operations are accurately captured and synchronized across the system.

In this process, Broker node of Cooper service distributes and processes each instruction in a fine-grained manner. Broker handles the fine-grained distribution and processing of each command. Curator monitors real-time file changes to ensure accurate version tracking. Binder broadcasts editing results to all subscribers. Emitter manages external interactions, ensuring precise and timely data transmission. By utilizing a distributed control mechanism, this invention achieves parallel processing of commands, significantly improving system responsiveness and avoiding bottlenecks inherent to centralized systems.

To resolve conflicts in multi-user collaborative editing, the invention combines Multi-Version Concurrency Control (MVCC) with real-time file system monitoring technologies (e.g., Linux's “inotify” and Windows' “FileSystemWatcher”). MVCC allows users to edit different versions of the same file concurrently. The system automatically detects and resolves conflicts. File system monitoring listens for user modifications in real time, ensuring that changes are promptly captured and communicated to other users. For example, when two developers simultaneously modify the same segment of code, the system detects the conflict and prompts them to either merge or select a resolution, avoiding the delays and restrictions of traditional locking mechanisms. This approach significantly enhances collaboration efficiency in multi-user environments.

The innovative design of virtual Peer nodes also enables front-end editors to seamlessly integrate with back-end services without requiring complex plugins or configurations. Acting as a bridge between the front-end and back-end. Peer nodes transmit user operations through the Vimcall protocol to the Cooper service, enabling bidirectional command transmission and real-time synchronization. This design simplifies system integration, allowing various front-end editors (e.g., Monaco Editor, VS Code) to integrate quickly, greatly improving system compatibility and flexibility.

In high-frequency collaborative operations, the invention optimizes command processing through the cooperation of Broker and Emitter nodes. Emitter nodes distribute editing commands by type to specific Broker nodes for specialized processing. This ensures that complex collaborative commands in high-frequency scenarios are handled without delays or conflicts. This mechanism is particularly suited for high-interaction scenarios in large-scale development projects, effectively overcoming the performance bottlenecks of traditional systems and significantly enhancing the speed and precision of collaborative editing.

By implementing the above methods, the invention achieves remarkable technical results in real-world applications:
1. Resolves issues of high-concurrency delays and data synchronization in existing technologies.
2. Enhances system stability and scalability through innovative architecture and design.
3. Combines MVCC with real-time monitoring to improve conflict resolution.
4. Introduces virtual Peer nodes for seamless integration, offering a high-efficiency, stable, and highly compatible solution for multi-user real-time collaborative editing.

This invention significantly improves efficiency and user experience across various collaborative scenarios, such as software development and document editing, making it a robust solution for modern collaborative environments.

### Example 3

In real-world enterprise collaboration scenarios, such as when multiple team members need to simultaneously edit, modify, and manage project files during the development process, traditional collaboration platforms often rely on centralized architectures. This approach centralizes data processing and struggles to ensure the real-time nature, security, and consistency of data. Especially in large-scale projects, frequent operations by multiple collaborators can cause slower system responses, operation delays, and data conflicts, ultimately affecting team collaboration efficiency and project timelines.

To address these challenges, this invention introduces the Cooper distributed control architecture and leverages unique platform-specific technologies to establish a new mode of collaborative work. In typical applications, initiators can invite designated users or share links to collaborate in real-time. Once collaborators accept the invitation, they join the session and perform operations through a proprietary collaboration protocol. These operations include actions such as adding, deleting, or renaming code files. Each collaborator's actions are synchronized in real-time across the system, ensuring that all participants can immediately view and edit file content.

In the implementation of this invention, the Cooper service employs a distributed architecture to manage collaborative workflows and file synchronization. The initiator's collaboration requests are transmitted through the Gateway to the Cooper service, which orchestrates the entire process. Every collaborator's actions are processed synchronously by the Peer service and broadcasted to all participants via WebSocket connections, ensuring content consistency. For example, when a collaborator edits a file, the changes are immediately synchronized to all other collaborators' terminals, eliminating the delays and inconsistencies commonly found in traditional centralized systems.

To enhance system security and reliability, this invention uses Multi-Version Concurrency Control (MVCC) combined with real-time file system monitoring to handle conflicts among multiple users. When several collaborators simultaneously modify the same file, the MVCC mechanism enables each user to edit their version of the file, with the system automatically resolving conflicts to ensure consistency in the final result. Additionally, real-time monitoring technologies, such as Linux's “inotify” or Windows' “FileSystemWatcher”, track file status changes to quickly detect and respond to user actions.

Furthermore, to enable seamless integration with external editors, the invention incorporates a virtual Peer node design, allowing front-end editors like Monaco Editor to act directly as agents for the Vimcall protocol and interact with the Cooper service. Virtual Peer nodes capture user actions and translate them into platform-compliant commands, mitigating the complexity and low compatibility issues typically associated with integrating front-end and back-end systems. For instance, when a developer performs an edit in Monaco Editor, the virtual Peer node synchronizes the action with the Cooper service in real time, enabling other collaborators to instantly see the changes. This significantly improves collaboration flexibility and system compatibility.

In practical applications, the multi-user real-time collaborative editing solution achieved by this invention resolves the shortcomings of traditional centralized processing systems. By employing fine-grained control and efficient synchronization mechanisms, it ensures data consistency and security. The system also manages multiple service instances and connections through the Cooper Service Manager and Peer Manager modules, maintaining stable performance under high-concurrency and high-frequency operations. Ultimately, this invention demonstrates significant improvements in enhancing collaboration efficiency, reducing conflicts, and optimizing user experiences in enterprise collaborative work scenarios. It showcases innovative advancements in data processing, system stability, and user interaction.

### Example 4

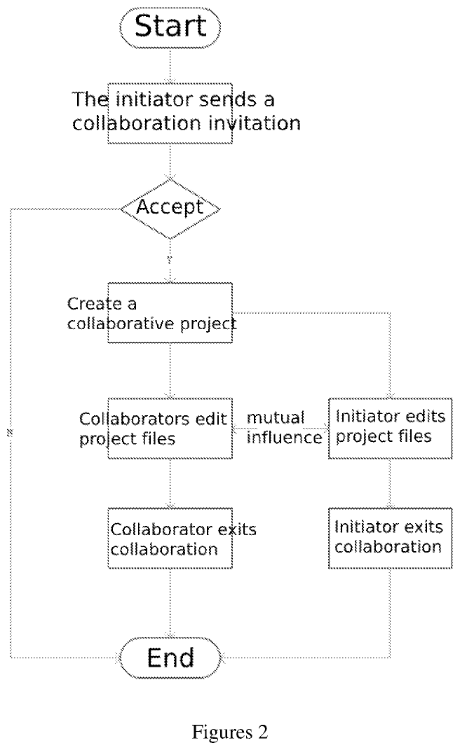

Refer to FIG. 2, a flowchart of the multi-user real-time collaborative editing process based on the Cooper distributed control system. This example illustrates the detailed operational process of multi-user real-time collaborative editing using the Cooper control system, showcasing the system's architectural design, operational steps, and the collaborative mechanism of its components.

### 1. Initiator Issues Collaboration Request

At the initial stage of collaborative editing, the initiator issues a collaboration request through the front-end interface, initiating the entire process. The Gateway service receives the request and forwards it to the Cooper service, where the Broker component processes the command, verifies its validity, and records the request information.

### 2. Invitation Acceptance

Collaborators receive the collaboration request from the initiator. The system performs identity verification using a connection handshake data structure (including project ID, path, username, permissions, etc.). Peer nodes establish a connection with the Cooper service through the Vimcall protocol. If the collaborator accepts the invitation, the system creates the collaborative project; otherwise, the process terminates.

### 3. Creation of Collaborative Project

When a collaborator accepts the invitation, the system creates the collaborative project. During this stage, the Broker component sets the project path based on the project ID and permissions, storing participant details and collaboration status in the database. The Curator component monitors the project directory in real-time and manages file subscriptions. The Binder component processes file subscription messages and broadcasts changes to all collaborators, ensuring file content synchronization.

### 4. Editing Project Files

During the collaboration, both the initiator and collaborators can edit project files. Peer nodes translate editing commands into OT (Operational Transformation) protocol data via the Vimcall protocol and send them to the Cooper Business Broker in the Cooper service. The Cooper service utilizes the Multi-Version Concurrency Control (MVCC) mechanism to handle edits from multiple users, automatically detecting and resolving conflicts to ensure real-time file content consistency.

### 5. Impact of File Edits

The system employs real-time file monitoring mechanisms, such as Linux's “inotify” or Windows' “FileSystemWatcher”, to detect file changes. When either the initiator or collaborators edit files, the Curator detects the changes and notifies the Binder. The Binder broadcasts the changes to all collaborators. The Emitter node sends the editing results back to the front-end, enabling real-time mutual updates between users and achieving seamless collaborative editing.

### 6. Collaborator Exit

Collaborators can exit the session at any stage of the collaboration. The Gateway service processes the exit request, updating the collaboration status in the database. The Peer Manager module manages Peer connection statuses, handling disconnections and resource releases during the exit process.

### 7. Initiator Exit

When the initiator exits, a shutdown request is sent via the Gateway, notifying all collaborators to terminate the session. The Cooper Service Manager module handles multiple Cooper service instances, coordinating the exit process to ensure system stability. Upon completion, the system logs all operations for auditing and troubleshooting.

### 8. Feature Enhancements and Modifications

To improve system stability and scalability, this implementation introduces the Broker and Emitter modules to enhance command processing efficiency. The Cooper Service Manager and Peer Manager further strengthen connection management capabilities.

The three-segment address modification allows direct interaction between commands and the Cooper service, optimizing data transmission stability.

Anomaly detection mechanisms automatically identify and handle front-end anomalies, such as Vim connection interruptions, ensuring system stability under high-concurrency and high-frequency collaboration scenarios.

### 9. Security and Privacy Protection

Data transmission is secured using SSL/TLS encryption protocols, safeguarding data security and privacy during collaboration.

Strict access control ensures that collaborative project data is secure, preventing unauthorized users from accessing sensitive information.

Through this example, the detailed implementation of a multi-user real-time collaborative editing solution based on the Cooper distributed control system is demonstrated. The system ensures stability, data consistency, and operational security in high-concurrency, multi-user collaboration scenarios, providing an efficient and reliable solution for collaborative work in areas such as software development and document editing.

### Example 5

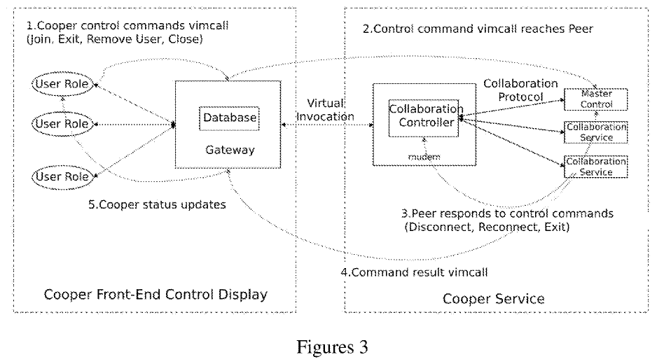

Referencing FIG. 3, this example provides a detailed explanation of the interaction process between the front-end and server in the Cooper system. It emphasizes how a distributed control architecture and communication protocol enable real-time multi-user collaborative editing. Below is an explanation of the architecture diagram and its implementation:

### 1. System Architecture and Component Descriptions

The diagram showcases the overall architecture of the Cooper system, comprising the front-end control layer and server-side collaboration layer. Key components include multiple user roles, a database, gateway, collaborative controller, master control, and collaboration services. These components interact via the Vimcall protocol and virtual invocation to ensure real-time editing and content synchronization.

User Roles: Represent participants (initiators or collaborators) in the collaborative editing session. Users interact with the system through the front-end interface (e.g., an editor) to send control commands for collaboration.

Database: Stores user information, collaboration project statuses, permission settings, and command logs, ensuring consistency and traceability of collaborative operations.

Gateway: Acts as a middleware between front-end users and back-end services, responsible for forwarding control commands and synchronizing user states, enhancing data transmission stability.

Collaborative Controller: The core module of the system, handling user command reception, processing, and feedback through virtual invocation. It interacts with internal collaborative service modules to execute specific collaborative actions.

Master Control: Manages multiple instances of collaborative services, coordinating the distribution and processing of commands, ensuring overall system scheduling.

Collaboration Services: Handle specific tasks such as file synchronization, command execution, and multi-version concurrency control (MVCC), managing user edits, conflict resolution, and real-time broadcasting.

### 2. Operation Workflow and Function Implementation

The workflow depicted in the diagram is as follows:

User Issues a Collaboration Command: Users send commands (e.g., join, exit, remove, close) through the front-end interface. These commands are transmitted to the gateway via the Vimcall protocol.

Command Reaches the Collaborative Controller: The gateway forwards the command to the collaborative controller through virtual invocation. The controller interprets the command and determines interaction with the collaborative protocol.

Peer Responds to the Command: The controller forwards the command to the Peer node, which executes the corresponding action (e.g., disconnect, reconnect, exit). During execution, the collaborative service module monitors and records changes to ensure updates and synchronization.

Command Results Feedback to the Front-End: After execution, the controller sends the results back to the front-end gateway via the Vimcall protocol. The gateway updates the database and the front-end interface, ensuring users see real-time collaborative effects.

Cooper State Updates: Any operation affecting the collaboration project's state triggers an automatic update in the database. Changes like user joins, exits, or file edits are recorded to maintain data consistency.

### 3. Details of Collaborative Editing Implementation

Multi-Version Concurrency Control (MVCC): During simultaneous multi-user edits, the collaborative service employs MVCC to manage conflicts. Each user's edit is recorded as a separate version, with the system automatically detecting conflicts and prompting users to merge or select versions, ensuring content accuracy and timeliness.

Real-Time File Monitoring and Synchronization: Collaborative controllers and service modules use file system APIs (e.g., Linux's inotify or Windows' FileSystemWatcher) to monitor file changes in real-time, ensuring all participants are immediately informed of modifications.

Security and Error Handling: The system implements strict permission controls and error detection mechanisms to safeguard data during operations. For issues like network interruptions or insufficient permissions, the system logs the anomalies and provides error notifications.

### 4. System Advantages and Application Scenarios

Through this architectural design and workflow, the Cooper system demonstrates outstanding performance and stability in high-concurrency, multi-user collaborative editing scenarios. Particularly in software development, document editing, and enterprise collaboration, the system effectively addresses latency, conflicts, and synchronization challenges commonly found in traditional centralized architectures, offering users a seamless collaboration experience.

In summary, the Cooper system achieves seamless connection and efficient collaboration between the frontend and backend through distributed control and virtual invocation, ensuring the efficiency and consistency of multi-user real-time editing.

For those skilled in the field, it is evident that the invention is not limited to the details of the exemplary embodiments described above. Other specific implementations of the invention can be achieved without departing from its spirit or fundamental characteristics. Therefore, in any aspect, the embodiments should be regarded as illustrative rather than restrictive. The scope of the invention is defined by the appended claims rather than the foregoing description, and all variations falling within the meaning and range of equivalence of the claims are intended to be included within the invention.

1. A multi-user real-time collaborative editing method based on virtual nodes and distributed control, comprising:
Step 1: Providing a distributed collaborative control system with multiple control nodes, including Broker, Curator, Binder and Emitter, to receive, process and distribute instructions via a distributed architecture.
Step 2: Creating virtual Peer nodes in front-end editors, serving as intermediaries between the editors and back-end Cooper services to enable data exchange and bidirectional instruction conversion, maintaining real-time interactions with Cooper services.
Step 3: Employing MVCC and real-time file system monitoring mechanisms to synchronize multi-user editing of the same file, monitor changes, and handle conflicts automatically.
Step 4: Utilizing the linkage mechanism between Brokers and Emitters to distribute collaborative editing instructions to corresponding Brokers for processing and return results to relevant collaborative nodes based on instruction types, ensuring efficient and accurate processing.
Step 5: Synchronizing multi-user real-time editing content using a distributed control architecture to ensure data consistency and real-time responsiveness while detecting and responding to abnormal operations through control nodes, enhancing system stability.

2. The multi-user real-time collaborative editing method based on virtual nodes and distributed control described in claim 1, characterized in that the virtual Peer nodes act as communication bridges between the editor and the backend service through the Vimcall protocol, enabling collaborative services such as joining, exiting, and data exchange.

3. The multi-user real-time collaborative editing method based on virtual nodes and distributed control described in claim 1, characterized in that the Broker node is used to receive collaborative commands, the Curator node monitors file system changes and manages file subscriptions, the Binder node processes individual file subscription messages and handles message broadcasting among subscribers, and the Emitter node serves as the external interaction interface of the system.

4. The multi-user real-time collaborative editing method based on virtual nodes and distributed control described in claim 1, characterized in that the multi-version concurrency control (MVCC) mechanism allows multiple users to simultaneously edit the same file, automatically detecting and handling concurrent conflicts to ensure the timeliness and consistency of file content.

5. The multi-user real-time collaborative editing method based on virtual nodes and distributed control described in claim 1, characterized in that the real-time file system monitoring mechanism uses file system APIs, such as Linux's “inotify” or Windows's “FileSystemWatcher”, to achieve real-time monitoring and updates of files.

6. The multi-user real-time collaborative editing method based on virtual nodes and distributed control as recited in claim 1, wherein: the distributed control system employs a three-tier address design, enabling direct command interaction between the front-end, Gateway, and Cooper services, thereby enhancing data interaction stability and response speed; the system further comprises a Cooper Service Manager module and a Peer Manager module, configured to manage multiple Cooper service instances and Peer node connection states, respectively, thereby enhancing system scalability and connection management capabilities; command processing involves a collaboration between a Broker and an Emitter based on an event-driven model, wherein a distributed architecture enables precise command control and efficient processing, optimizing system performance in high-frequency multi-user interaction scenarios; data transmission is encrypted using SSL/TLS encryption protocols, ensuring data security and privacy during collaborative editing; and users are enabled to invite other members to participate in collaboration through external links, account searches, or email invitations, and to set permission levels for different members, ensuring project data security and controllability.
